(19) United States
(12) Patent Application Publication
(10) Pub. No.: US 2012/0257971 A1
(43) Pub. Date: Oct. 11, 2012

(54) WindJet ® Turbine Ring

(76) Inventor: Scott Schmutzer, Pinckney, MI (US)

(21) Appl. No.: 13/020,383

(22) Filed: Apr. 11, 2011

(51) Int. Cl. F03D 1/06

(52) U.S. Cl. 416/131; 416/189; 416/169 R

(57) ABSTRACT

A series of rings in varying diameters, divided by sets of formed fins arranged in an offset pattern. The offset pattern was inspired by a non-wind apparatus namely a conventional hand cheese grater. Such a pattern has proven to create superior lift, torque, and thus rotation when applied to the Windjet® Turbine Ring. The WindJet® Turbine Ring experiences high revolutions which power hydraulic motors that transfer power into an electrical generation system found at the base of the tower.

### CROSS-REFERENCE TO RELATED APPLICATIONS

U.S. Pat. No. 7,775,760; August/2010; Alfred Finnell; a turbine wheel configuration utilizing the exterior portion of the wheel for a blade placement.

U.S. Pat. No. 4,648,801; March/1987; Robert Wilson; a conventional bladed wind turbine.

U.S. Pat. No. 4,729,716; March/1988; Guenter Schmidt; a wind turbine utilizing a wheel formation with blades attaching the hub to the exterior wheel.

U.S. Pat. No. 7,323,792; January/2008; Chester Sohn; a wind turbine with center wheel with extending blades outside of ring.

### BACKGROUND OF INVENTION

1. Field of the Invention

The present disclosure is based on the generally accepted laws and principles of “Betz Law”, “Bernoulli Principle”, and “Newton's 3^{rd} Law”. Each as it relates to maximizing the extraction of Kinetic energy and it's conversion to mechanical energy, further enhancing the potential and efficiencies of the flow of wind patterns. More particularly, the present disclosure relates to a turbine ring having a large surface area with an offset pattern of fins.

2. Background Information

Public awareness embraces alternative energy as a solution to the rising utility costs involving energy production. Efforts must continue to be made where technology is improved through more recent innovative technology involving the kinetic power of wind. Current conventional wind systems utilize a series of blades projecting radially from a centrally located hub; axially attached to the hub is a shaft, in a manner that said shaft is fitted axially in rotary assembly with respect to the body of the wind turbine, in which the stator of the electric generator is mounted in a fixed position, whilst the rotary arrangement of the shaft is established by means of a coupling using bearings.

This configuration design provides several limitations. A first limitation is efficiency. The energy utilized to turn an object is referred to as torque. The torque is calculated at a force times a distance from the center of rotation. The force applied near the center of rotation has a significantly lower impact than a force applied towards the outer edge of the blades, although resistance is created along the entire length of the blade. A second limitation concerns the costly installation of the enormously weighted conventional systems and their design assembly making for costly repairs as well requiring. A third limitation is the noise, vibration and resonance during operation due to all the component parts and how they're designed for assembly. A fourth limitation is that the conventional systems require for an electric drive motor for rotating the blades into the desired wind path for harnessing the wind for rotation. This electric drive motor has been observed by the wind industry to be one of the highest failure components to the conventional system. A fifth limitation is the need for internal transmission which is also identified as experiencing a high failure rate. A sixth limitation involves a required minimum and maximum wind speeds for operation.

Therefore, a wind driven turbine ring with improved efficiency, ease of installation, no noise, no vibration, no resonance, elimination of electric drive motor or internal transmission, and a broad range of wind speeds for optimal turbine rotation is needed.

### SUMMARY OF THE INVENTION

The present disclosure is generally directed to a wind driven turbine, and more specifically to a turbine ring device having that maximizes a specific ring area with formed fins placed in an offset pattern, which has proven to increase power output of electrical, hydraulic, and pneumatic generation devices. The fins allow for a pass through configuration for the wind creating clean air for the next WindJet® Turbine Ring.

This invention utilizes a series of rings of varying diameters separated by a set of individual fins that function in a down-wind configuration to form a wheel of fins that utilize the full pattern of the winds movement as it passes through the face of the leading edge of the ring.

This invention addresses the first limitation noted above concerning efficiency. Utilizing more area with the formed fins increases both torque and lift in conjunction with the WindJet® Hydraulic Design© allows for higher conversion of energy production.

This invention eliminates difficult and costly Installations by eliminating massive weights and sizes involved. The invention is ⅕ the size of a conventional system and because of the Innovative WindJet® Hydraulic Design© the generator is held at the base of the tower.

This invention eliminates noise, vibration and resonance by the simplistic assembly of parts needed for installation. The ring is attached at the top of the tower by a coupling and rotates on a bearing.

This invention eliminates the need for an electric drive motor by utilizing a downwind configuration where the turbine ring experiences an ability to self-yaw according with the direction of the wind.

This invention eliminates the requirement for an internal transmission as the superior design for placing fins throughout the entire ring configuration as rotational frequency is not a concern given wind speeds as low as 4 mph begin rotating the turbine ring.

This invention is not limited by wind speeds requiring braking the system as blade fatigue failure is not applicable. The turbine ring can spin unlimited.

In some embodiments, the wind turbine apparatus may include:
a peripheral ring having a radius defined from the circumference of the ring;
central rings having a radius defined from the circumference of the ring;
a central hub having a hub radius defined from a hub center to an exterior edge of the hub;
a radial span dimension being defined as the overall diameter of the peripheral ring;
a series of formed fins positioned in an offset pattern separating and joining the rings;
a series of precise machined patterns are cut into flat face on both sides of the Inner ring which corresponds to the dimensions and shape of the fins;
wherein each of the fins is attached to the wind turbine rings positioning the fins within the various rings and proximate the entire circumference of the ring configuration, leaving an airflow gap between an interior edge of the fins and the exterior edge of the patterned fins.

In another aspect, the self-yawing characteristic is accomplished by the constant air pressure pattern across the entire area of the turbine ring when exposed to a constant wind regime.

In another aspect, the turbine ring engages with an electrical power generator, hydraulic motor or pneumatic motor.

In yet another aspect, the deployed assembly can additionally include a rotational means, rotating about a vertical axis to reduce the frontal area respective to the airflow.

### DETAILED DESCRIPTION OF THE PREFERRED EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description.

The present disclosure is generally directed to a WindJet® Turbine Ring and the integration of the WindJet® Turbine Ring onto a turbine deployment assembly. The WindJet® Turbine Ring and the respective application are detailed hereinafter.

Referring initially to FIGS. 1 through 14 of the drawings, an illustrative embodiment of a turbine ring, hereinafter apparatus is generally indicated by reference FIG. 1. The turbine ring assembly includes assembly rings separated by a configuration of fins allowing the turbine center hub FIG. 3 to rotate about an axle that would be assembled to the axle bearing. The axle can be of any known rotational interface capable of supporting the forces exerted by the wind and respective motion of the turbine ring. The turbine fins FIG. 11, 12, 13, 14 are preferably assembled having a permanent position between the varying dimensions of the ring configurations.

The turbine fins can be configured in a variety of shapes and angles of attack as illustrated in FIGS. 1, 11, 12, 13, and 14; where FIG. 1 is numbered to show which angle of fins shown in FIGS. 11, 12, 13 and 14 are assembled. A planar view of the turbine fins is presented in FIG. 2, having an airfoil cross sectional shape bounded by a fin leading edge, a fin trailing edge, a posterior edge and an interior edge. The turbine fins can be configured of a variety of cross sectional and peripheral shapes shown in FIGS. 11, 12, 13, 14. The configuration defines the total surface area. The surface area, cross sectional shapes and peripheral shape all affect the efficiency of the turbine fins. The interior edge provides an arched lower edge wherein the fin trailing edge is equal to or slightly shorter than the fin leading edge. A planar view of a turbine fin is presented in FIG. 2, having an airfoil cross sectional shape bounded by a fin leading edge, a fin trailing edge, a posterior edge and an interior edge. The interior edge provides a “C” shaped lower edge having a continuous line blending into the fin trailing edge, and wherein the fin trailing edge is shorter than the fin leading edge. A planar view of a turbine fin is presented in FIGS. 11, 12, 13, 14, having an airfoil cross sectional shape bounded by a fin leading edge, a fin trailing edge, a posterior edge and an interior edge. The interior edge provides an arched shaped lower edge wherein the fin trailing edge is significantly shorter than the fin leading edge.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence

### IDENTIFICATION OF DRAWINGS

FIG. 1 Provides a perspective drawing of the front view of turbine ring, referencing by numbers component parts for identifying following Figure drawings

FIG. 2 presents a planar view of turbine ring

FIG. 3 presents front view of hub component with center mounting hole (1)

FIG. 4 presents a planar view of hub (1)

FIG. 5 presents outer diameter ring dimension front view

FIG. 6 presents outer diameter ring dimension planar view

FIG. 7 presents second ring dimensions front view

FIG. 8 presents second ring dimensions planar view

FIG. 9 presents third ring dimension front view

FIG. 10 presents third ring dimension planar view

FIG. 11 presents fixed angle position of fin array (3)

FIG. 12 presents fixed angle position of fin array (4)

FIG. 13 presents fixed angle position of fin array (5; 6)

FIG. 14 presents fixed angle position of fin array (7; 8)

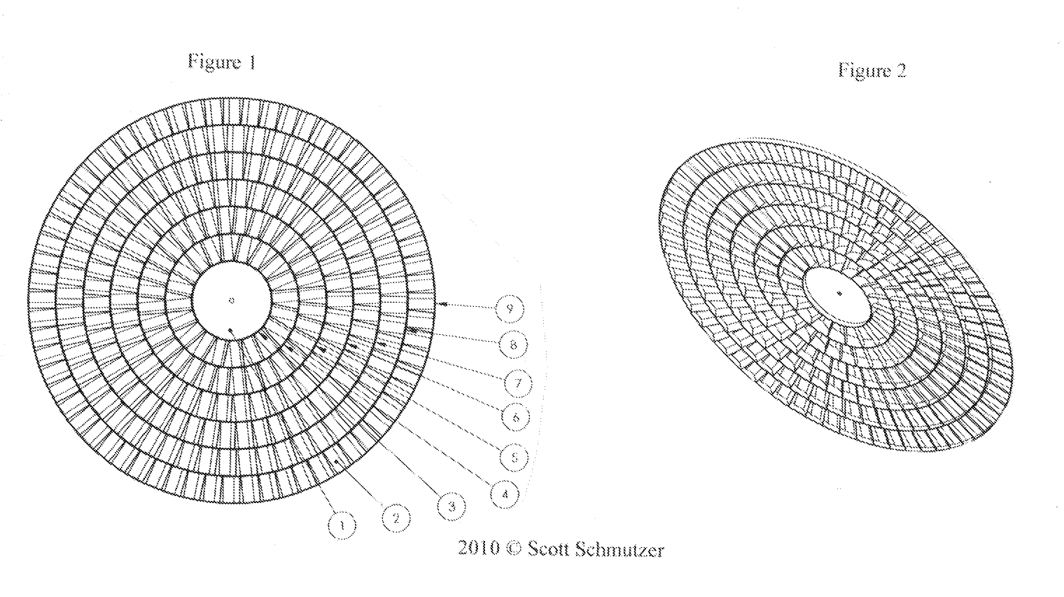

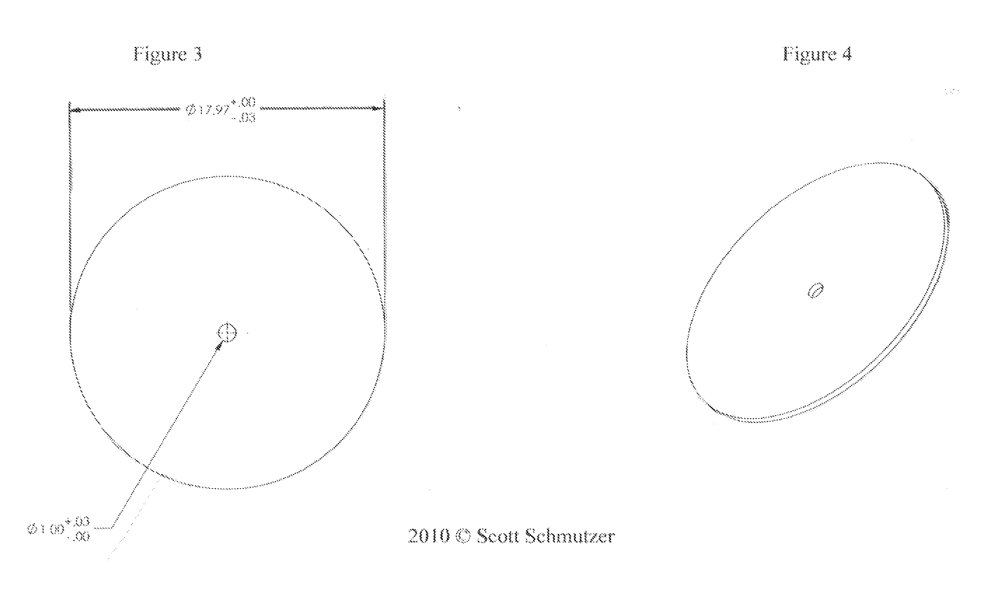

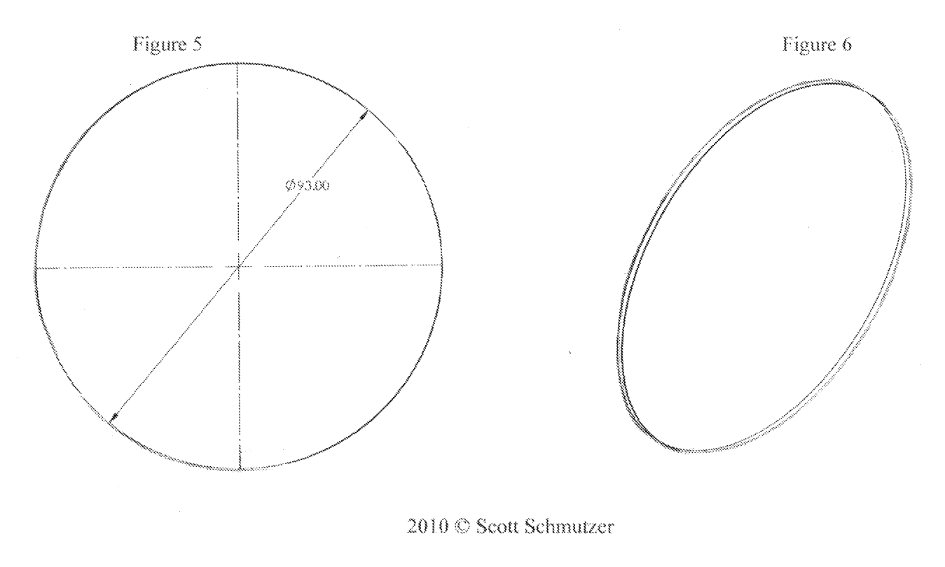

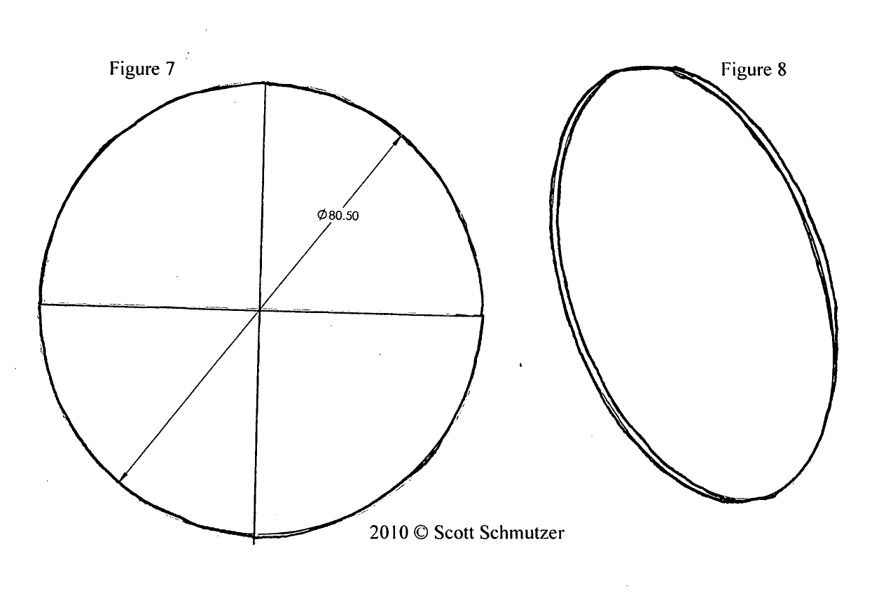

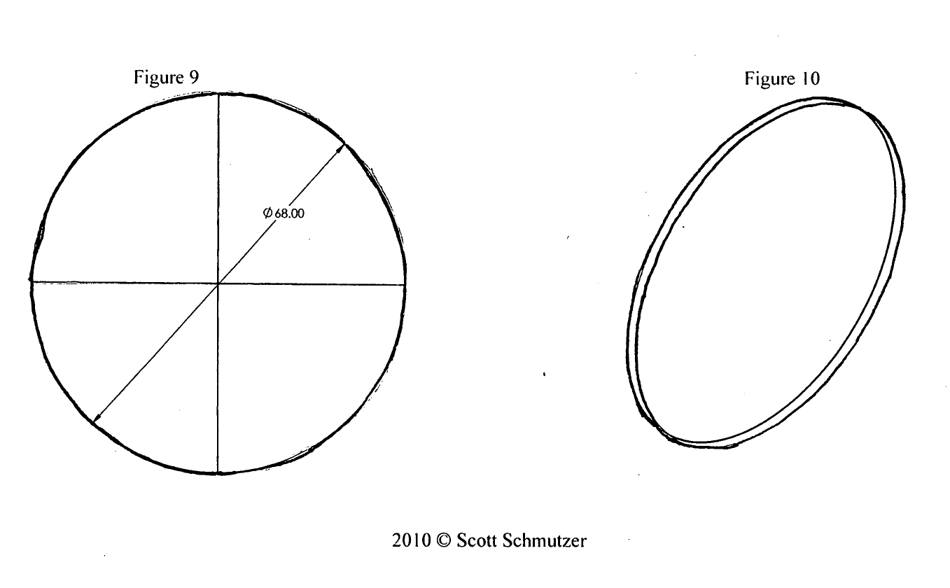

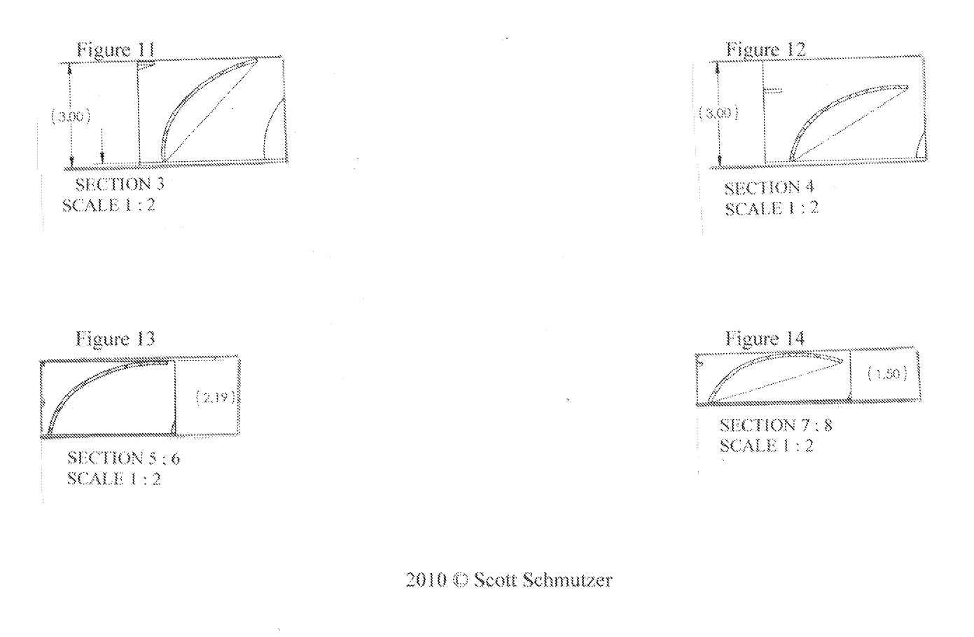

What is claimed is:

1. A turbine ring, comprising: a peripheral rim having a rim radius defined from a diameter dimension; a central hub having a hub radius defined from a hub center to an exterior edge of the hub; a radial span dimension being defined as rim the diameter; a series of rings in varying diameters, separated by a series of fins; and a series of turbine fins having a radial fin dimension being significantly less than the radial span dimension; wherein each of the turbine fins being assembled to the wind turbine apparatus having a leading edge in operable communication with a respective fin and positioned within the varying and peripheral ring, proximate the interior edge of the rim, leaving an airflow gap between an interior edge of the fins and the exterior edge of the hub.

2. A turbine ring as recited in claim 1, wherein the fins are in positioned between a series of varying diameter rings covering the entire inner area of a ring configuration.

3. A turbine ring as recited in claim 1, wherein the positioning of the fins within the variable rings creates a larger surface area for harnessing the wind allowing for higher frequency of rotation.

4. A turbine ring as recited in claim 1, the turbine ring further comprising: larger surface area creates ability for energy production to begin at low wind speeds.

5. A turbine ring as recited in claim 1, wherein the fins are positioned to create a downwind system for harnessing the wind.

6. A turbine ring as recited in claim 1, wherein the outer ring surface allows for natural self-yawing of turbine ring.

7. A turbine ring as recited in claim 1, wherein each of the turbine fins partially overlaps an adjacent turbine fin, arranged having the leading edge of a turbine fin on a downwind receiving side of a trailing edge of the adjacent fin.

8. A turbine ring, comprising: a peripheral rim having a rim radius defined from a diameter dimension; a central hub having a hub radius defined from a hub center to an exterior edge of the hub; a radial span dimension being defined as rim radius minus the hub radius; a series of rings in varying diameters, separated by a series of fins; and a series of turbine fins having a radial fin dimension being significantly less than the radial span dimension; an array of fins attaching a leading edge of the turbine fins to the rings; and an Internal hydraulic braking mechanism when excessive wind force maximizes the generative system, which brakes the turbine ring when exposed to an excessive wind force, wherein each of the fins is assembled to the wind turbine apparatus positioning the fins within the peripheral ring and proximate the interior edge of the rim, leaving an airflow gap between an interior edge of the blades and the exterior edge of the hub.

9. A turbine ring as recited in claim 8, a hydraulic braking mechanism is in place in case of excessive wind speeds.

10. A turbine ring as recited in claim 8, the ring further comprising: an auto-restoring mechanism for returning a released turbine blade to an operational configuration.

11. A wind driven electrical energy producing assembly, comprising: a vertical tower extending upwards from a ground; an electrical power generator positioned proximate at the bottom section of the vertical tower; a turbine ring in communication with an axle of the electrical power generator; the turbine ring comprising: a peripheral rim having a rim radius defined from a rim center to an interior edge of the rim; a central hub having a hub radius defined from a hub center to an exterior edge of the hub; a radial span dimension being defined as rim radius minus the hub radius; an array of fins assembling the central hub to a rotationally centralized position within the peripheral rim; a series of turbine fins having a radial ring dimension being significantly less than the radial span dimension; and a breakaway release hydraulic mechanism, which releases the turbine ring rotation when exposed to an excessive wind force, wherein the each of the fins is assembled to the wind turbine apparatus positioning the fins within the peripheral ring and proximate the interior edge of the rim, leaving an airflow gap between an interior edge of the fins and the exterior edge of the hub.

12. A wind driven electrical energy producing assembly as recited in claim 11, wherein each of the turbine fins partially overlap an adjacent turbine fin, arranged having the leading edge of a turbine fin on a wind receiving side of a trailing edge of the adjacent fin.

13. A wind driven electrical energy producing assembly as recited in claim 11, wherein the fins are in a fixed position in varying angles of attack.

14. A wind driven electrical energy producing assembly as recited in claim 11, wherein the incident angle is in a fixed position.

15. A wind driven electrical energy producing assembly as recited in claim 11, the turbine ring further comprising: an auto-restoring mechanism for returning a released turbine ring to an operational configuration.
